(19) United States
(12) Patent Application Publication
(10) Pub. No.: US 2026/0257301 A1
(43) Pub. Date: Sep. 3, 2026

(54) MICROTEXTURIZED SUBSTRATES AND METHODS FOR PRODUCING THE SAME

(71) Applicant: University of Virginia Patent Foundation, Charlottesville, VA (US)

(72) Inventors: Mool C. GUPTA, Keswick, VA (US); Anustup CHAKRABORTY, Charlottesville, VA (US); Benjamin CHALFANT, Belmont, MA (US)

(21) Appl. No.: 18/875,357

(22) PCT Filed: Jun. 30, 2023
(86) PCT No.: PCT/US2023/069470

§ 371 Date: Dec. 16, 2024

Related U.S. Application Data
(60) Provisional application No. 63/357,458, filed on Jun. 30, 2022.

(51) Int. Cl. B23K 26/352; B23K 26/0622

(52) U.S. Cl. CPC B23K 26/355; B23K 26/0622

(57) ABSTRACT

In accordance with the purpose(s) of the present disclosure, as embodied and broadly described herein, the disclosure, in one aspect, relates to methods for producing a microtextured surface on a substrate. The method involves the surface of the substrate to a pulsed laser across the substrate at a controlled overlap of each pulsed laser to produce the microtextured surface. The morphology of the microtextured surface can be varied by controlling the laser processing parameters. The microtextured surfaces produced by the methods described herein possess a significantly higher adhesion strength to surface coatings such as, for example, metal coatings when compared to conventional texturizing techniques.

### CROSS-REFERENCE TO RELATED APPLICATIONS

This application claims the benefit of U.S. Provisional Application No. 63/357,458, filed on Jun. 30, 2022, which is incorporated herein by reference in its entirety.

### BACKGROUND

Surface modifications have been shown to improve the surface properties of materials. For example, surface microtexturing has been used to achieve a superhydrophobic or superhydrophilic surface. Some of the commonly used surface microtexturing techniques are chemical etching, electrical discharge, and sandblasting. Surface treatments can remove contaminants from surfaces as well as changing their physio-chemical properties.

Among the different known surface treatment techniques, grit-blasting is a widely used method, but one of the main disadvantages of using this technique is that it does not allow selective roughening and does not create any fixed and repeated pattern. Grit-blasting also leads to grit entrapment. Other surface treatments may require application of chemicals. In some cases, coatings may fail when applied to microtextured surfaces produced by conventional techniques.

Despite advances in surface microtexture research, there is still a scarcity of effective methods for microtexturing various substrates that results in surfaces having improved bonding strength, the ability to produce patterns on the surfaces, and other benefits. An ideal method would also be customizable and able to produce features of desired heights and/or spacing to suit the needs of particular applications and would lead to increased longevity and lower maintenance costs of metal parts across a variety of industries. These needs and other needs are satisfied by the present disclosure.

### SUMMARY

In accordance with the purpose(s) of the present disclosure, as embodied and broadly described herein, the disclosure, in one aspect, relates to methods for producing a microtextured surface on a substrate. The method involves the surface of the substrate to a pulsed laser across the substrate at a controlled overlap of each pulsed laser to produce the microtextured surface. The morphology of the microtextured surface can be varied by controlling the laser processing parameters. The microtextured surfaces produced by the methods described herein possess a significantly higher adhesion strength to surface coatings such as, for example, metal coatings when compared to conventional texturizing techniques.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows laser experimental setup with a galvanometer that can control laser scanning in 2D directions for laser processing of aluminum substrates.

FIGS. 2A-2F show (FIG. 2A) SEM image of untextured aluminum surface; SEM image of laser microtextured aluminum surface at fluence of (FIG. 2B) 0.38 J/cm², (FIG. 2C) 0.45 J/cm², (FIG. 2D) 0.61 J/cm², (FIG. 2D) 0.76 J/cm², (FIG. 2F) 0.91 J/cm². The frequency and the scanning speed were kept constant at 400 kHz and 60 mm/s, respectively.

FIGS. 3A-3D show SEM image of laser microtextured aluminum surface at (FIG. 3A) 20 kHz, (FIG. 3B) 200 kHz, (FIG. 3C) 300 kHz, (FIG. 3D) 600 kHz. The fluence and the scanning speed were kept constant at 0.916 J/cm² and 60 mm/s respectively.

FIG. 4 shows a SEM image of the surface of a grit-blasted sample.

FIG. 5 shows sample assembled for tensile adhesion testing; Bond Coat—Coating layer that is attached to the sample; Top Coat—Coating Layer that is attached to the glue.

FIG. 6 shows a SEM image of plane untextured Al 7075 surface.

FIG. 7 shows a SEM image of laser microtextured (0.763 J/cm², 60 mm/s, 400 kHz) aluminum sample.

FIG. 8 shows a SEM image of laser textured (0.916 J/cm², 60 mm/s, 400 kHz) aluminum sample.

FIG. 9 shows a SEM image of laser microtextured (0.803 J/cm², 60 mm/s, 600 kHz) aluminum sample.

FIG. 10 shows feature height variations on aluminum substrate. Line #1—0.763 J/cm², 60 mm/s, 400 kHz; Line #2—0.916 J/cm², 60 mm/s, 400 kHz; Line #3—0.803 J/cm², 60 mm/s, 600 kHz; GB—Grit-blasted. Sq: RMS roughness; Sz: Max peak to Max valley distance; Sa: Average roughness; The line #denotes the different laser parameters used.

FIG. 11 shows a 3D surface profile of a grit-blasted sample.

FIGS. 12A-12B show (FIG. 12A) 3D surface profile of Line #1; (FIG. 12B) 2D surface profile of Line #1; Axes scales are in microns.

FIGS. 13A-13B show (FIG. 13A) 3D surface profile of Line #2; (FIG. 13B) 2D surface profile of Line #2; Axes scales are in microns.

FIGS. 14A-14B show (FIG. 14A) 3D surface profile of Line #3; (FIG. 14B) 2D surface profile of Line #3; Axes scales are in microns.

FIGS. 15A-15B show (FIG. 15A) SEM cross-section image of the interface of line #3 and Amdry 9951; (FIG. 15B) EDS spectra showing elemental composition of the interface of line #3 and Amdry 9951; Line #3-0.803 J/cm², 60 mm/s, 600 KHz.

FIGS. 16A-16B show (FIG. 16A) SEM cross-section image of the interface of line #3 and Amdry 995C; (FIG. 16B) EDS spectra showing elemental composition of the interface of line #3 and Amdry 995C Line #2-0.916 J/cm², 60 mm/s, 400 KHz.

FIG. 17 shows a SEM cross-section image of the interface of grit-blasted (GB) surface and Amdry 995C.

FIG. 18 shows a surface showing thermally sprayed coating on grit-blasted aluminum sample after tensile adhesion measurement test has been performed. Coating failure shows delamination of the thermally sprayed coating on a grit-blasted aluminum sample after the adhesion testing.

FIG. 19 shows adhesion strength for grit-blasted and laser microtextured samples. Line #1-50%, 60 mm/s, 400 kHz; Line #2-60%, 60 mm/s, 400 kHz; Line #3-50%, 60 mm/s, 600 kHz; Line #4-Grit-blasted.

FIGS. 20A-20B show an interface showing (FIG. 20A) Infiltration of Amdry 995C powder on laser microtextured surface; (FIG. 20B) Infiltration of Amdry 9951 on laser microtextured surface. Infiltration of Amdry 9951 into the grooves is much more than that of 995C due to the smaller mean particle size.

FIGS. 21A-21C show the cross-sectional overlap of two pulsed laser beams at different percentages of overlap.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a coating,” “a substrate,” or “an average feature height,” include, but are not limited to, mixtures, combinations, and/or series of two or more such coatings, substrates, or average feature heights, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

The term “laser” as used herein is light produced from a laser device.

A “pulsed laser” refers to a laser where the optical power appears in pulses of some duration at some repetition rate and not a continuous wave of light.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere).

### Methods for Producing Microtexturized Substrates

Described herein are methods for producing a microtextured surface on a substrate. The method involves subjecting the surface of the substrate to a laser to produce the microtextured surface.

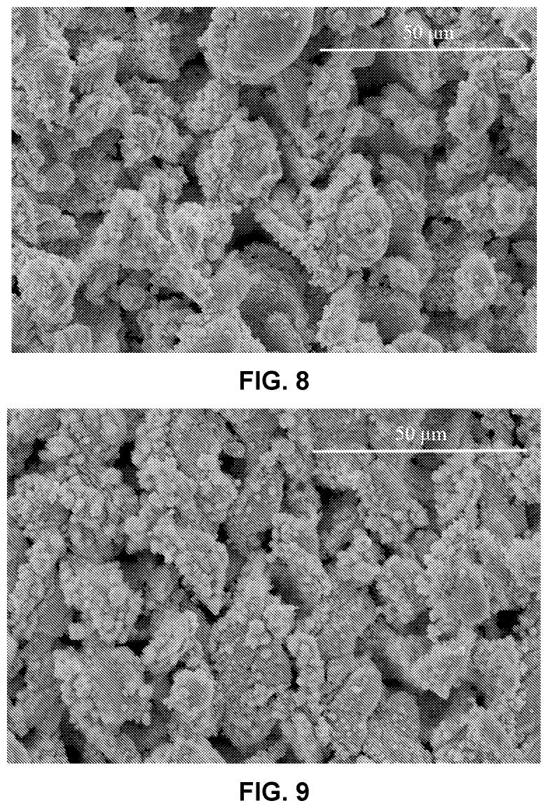

The morphology of the microtextured surface can be varied by controlling the laser processing parameters. In one aspect, the methods described herein produce a surface composed of a plurality of features. The features present on the microtextured surface can have a variety of shapes and dimensions. In one aspect, the features are in the form of aligned pillars. An example of this structural morphology is shown in FIGS. 7-9.

In one aspect, the average height of the features is about 0.1 μm to about 50 μm across the microtextured surface, or about 0.1 μm, 1 μm, 5 μm, 10 μm, 20 μm, 30 μm, 40 μm, or 50 μm, where any value can be a lower and upper endpoint of a range (e.g., 10 μm to 30 μm). In another aspect, the average spacing between each of the features is from about 0.1 μm to about 50 μm, or about 0.1 μm, 1 μm, 5 μm, 10 μm, 20 μm, 30 μm, 40 μm, or 50 μm, where any value can be a lower and upper endpoint of a range (e.g., 10 μm to 30 μm). The methods described herein can be used to microtexturize a variety of substrates including, but no limited to, metals, ceramics, polymers, composites, alloys, or glass. In another aspect, the substrate comprises aluminum, copper, nickel, iron, or an alloy thereof.

The selection of the pulsed laser can vary depending upon the amount of desired microtexturizing as well as the material of the substrate to be microtexturized. By modifying the pulsed laser parameters as discussed below, the dimensions of the features produced on the microtexturized substrate can be modified. By modifying the features on the microtexturized substrate, the adhesion of coatings can be enhanced significantly when compared to untextured substrates and a textured substrate produced by conventional methods such as grit-blasting.

In one aspect, the pulsed laser has a wavelength range of about 250 nm to about 11,000 nm.

In one aspect, the pulsed laser is an ultraviolet laser. In one aspect, the ultraviolet laser has a wavelength of from about 250 nm to about 450 nm, or about 250 nm, 275 nm, 300 nm, 325 nm, 350 nm, 375 nm, 400 nm, 425 nm, or 450 nm, where any value can be a lower and upper endpoint of a range (e.g., 325 nm to 400 nm).

In another aspect, the pulsed laser is an infra-red laser. In one aspect, the infra-red laser has a wavelength of from about 900 nm to about 1,100 nm, or about 900 nm, 925 nm, 950 nm, 975 nm, 1,000 nm, 1,025 nm, 1,050 nm, 1075 nm, or 1,100 nm, where any value can be a lower and upper endpoint of a range (e.g., 1,000 nm to 1,100 nm). In another aspect, the infrared laser has a wavelength of about 1,064 nm.

In one aspect, the pulsed laser has a wavelength of from about 400 nm to about 600 nm, or about 400 nm, 425 nm, 450 nm, 475 nm, 500 nm, 525 nm, 550 nm, 575 nm, or 600 nm, where any value can be a lower and upper endpoint of a range (e.g., 525 nm to 550 nm). In another aspect, the laser is produced by an ytterbium fiber laser.

Depending upon the selection of the pulsed laser, the power of the laser can vary. In one aspect, the pulsed laser is applied at from about 20% laser power to about 80% laser power, or about 20%, 25%, 30%, 35%, 40%, 45%, 50%, 55%, 60%, 65%, 70%, 75%, or 80%, where any value can be a lower and upper endpoint of a range (e.g., 30% to 50%). In another aspect, the laser is applied at a power of from about 1 W to about 1,000 W, or about 1 W, 10 W, 20 W, 30 W, 40 W, 50 W, 60 W, 70 W, 80 W, 90 W, 100 W, 200 W, 300 W, 400 W, 500 W, 600 W, 700 W, 800 W, 900 W, or 1,000 W, where any value can be a lower and upper endpoint of a range (e.g., 20 W to 40 W).

In another aspect, the pulsed laser has a frequency of about 1 Hz to about 100 MHz, or about 1 kHz, 10 kHz, 20 kHz, 30 kHz, 40 kHz, 50 kHz, 60 kHz, 70 kHz, 80 kHz, 90 kHz, 100 kHz, 200 kHz, 300 kHz, 400 kHz, 500 kHz, 600 kHz, 700 kHz, 800 kHz, 900 kHz, or 1,000 kHz, where any value can be a lower and upper endpoint of a range (e.g., 1 Hz to 100 MHz).

In another aspect, the pulsed laser has a pulse energy of from about 1 μJ to about 100 J, or 1 μJ, 0.1 J, 0.5 J, 1.0 J, 5 J, 10 J, 20 J, 30 J, 40 J, 50 J, 60 J, 70 J, 80 J, 90 J, or 100 J, where any value can be a lower and upper endpoint of a range (e.g., 0.5 J to 5 J).

In other aspects, the diameter of the pulsed laser can be modified. In one aspect, the pulsed laser has a beam size of from about 1 μm to about 100 μm, or 1 μm, 5 μm, 10 μm, 20 μm, 30 μm, 40 μm, 50 μm, 60 μm, 70 μm, 80 μm, 90 μm, 100 μm, 1 mm, 10 mm, 50 mm, or 100 mm, where any value can be a lower and upper endpoint of a range (e.g., 10 μm to 30 μm).

In another aspect, the pulsed laser is applied to the metal at a scan speed of from about 0.1 mm/s to about 10,000 mm/s, or about 0.1 mm/s, 10 mm/s, 50 mm/s, 100 mm/s, 200 mm/s, 300 mm/s, 400 mm/s, 500 mm/s, 600 mm/s, 700 mm/s, 800 mm/s, 900 mm/s, 1,000 mm/s, 2,000 mm/s, 3,000 mm/s, 4,000 mm/s, 5,000 mm/s, 6,000 mm/s, 7,000 mm/s, 8,000 mm/s, 9,000 mm/s, or 10,000 mm/s, where any value can be a lower and upper endpoint of a range (e.g., 400 mm/s to 600 mm/s).

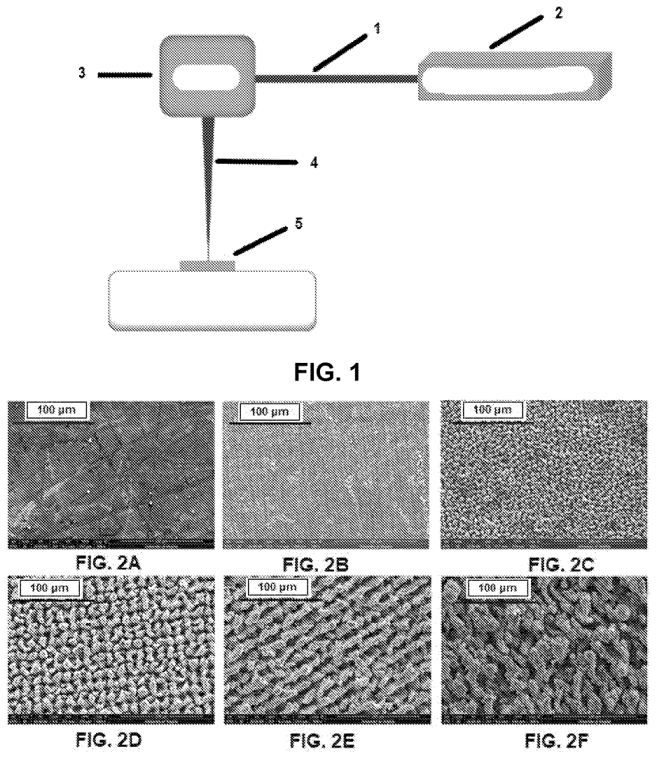

An exemplary schematic for producing microtexturized surfaces using the methods described herein is provided in FIG. 1. Referring to FIG. 1, a pulsed laser 1 produced from laser device 2 is directed onto substrate 5. The pulsed laser beam 1 is applied to the substrate using a galvanometer 3 to specifically target or direct the pulsed laser 4 to a specific cite on the substrate 5. In one aspect, during microtexturizing with the pulsed laser, air or an inert gas such as nitrogen or argon can be blown on the substrate while the substrate is subjected to the pulsed laser. In one aspect, the pulsed laser is mounted on translation stage. Here, the pulse laser can be moved in any direction (i.e., x- or y-axis) relative to the substrate to microtexturize specific regions of the substrate.

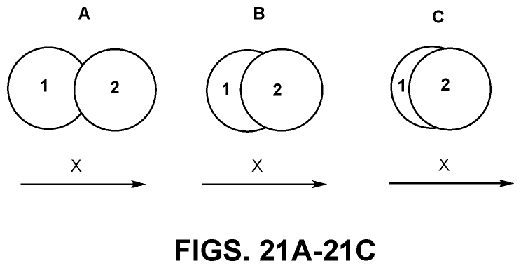

The surface is subjected to a plurality of pulsed lasers (i.e., the substrate surface is exposed multiple laser beams). Depending upon the amount of texturizing and feature dimensions to be produced on the substrate surface, the spacing of each laser beam relative to one another can vary. This is referred to herein as “controlled overlap of each pulsed laser.” For example, the substrate surface can be subjected to two laser beams that each produce a laser spot on the substrate surface. Depending upon the positioning of each laser beam, the laser spots overlap or, in the alternative, there is no overlap. In one aspect, the overlap between each laser (i.e., laser spot) along a direction of scanning is from about 0% to about 99.5%, or 0%, 5%, 10%, 20%, 30%, 40%, 50%, 60%, 70%, 80%, 90%, or 99.5%, where any value can be a lower and upper endpoint of a range (e.g., 40% to 60%). FIGS. 21A-21C show the cross-sectional overlap of two pulsed laser beams at different percentages of overlap along a direction of scanning of the pulsed laser (depicted as X).

In certain aspects, the surface of the substrate to be microtexturized and be pre-treated prior to being microtexturized. In one aspect, the surface of the substrate is polished to a surface roughness of less than 1 μm prior to subjecting the surface of the substrate to the pulsed laser. In another aspect, the surface of the substrate is abraded to roughness of from about 0.01 μm to about 20 μm prior to microtexturizing. For example, the surface can be abraded with sand paper.

The microtexturized substrates produced herein possess several unique physical properties. For example, the microtextured surfaces produced herein possess a significantly increased surface area and contact area ratio when compared to the base substrate not microtexturized. In one aspect, the microtexturized substrate has a surface area that is at least 40%, at least 50%, at least 60%, at least 70%, or at least 80% greater than the base substrate.

In one aspect, the microtexturized substrate has a surface energy of from about 1 mN/m to about 2,000 mN/m, or 1 mN/m, 10 mN/m, 50 mN/m, 100 mN/m, 200 mN/m, 300 mN/m, 400 mN/m, 500 mN/m, 600 mN/m, 700 mN/m, 800 mN/m, 900 mN/m, 1,000 mN/m, 1,500 mN/m, or 2,000 mN/m, where any value can be a lower and upper endpoint of a range (e.g., 500 mN/m to 1,000 mN/m). Techniques for determining the surface energy of the microtexturized substrates produced herein are provided in the Examples.

In another aspect, the hydrophilic/hydrophobic properties of the microtexturized substrates can be modified. In one aspect, the microtexturized substrate has a water contact angle of from about 1° to about 175°, or 1°, 10°, 25°, 50°, 75°, 100°, 125°, 150°, or 175°, where any value can be a lower and upper endpoint of a range (e.g., 10° to 100°). Techniques for determining the water contact of the microtexturized substrates produced herein are provided in the Examples.

The microtextured surfaces produced by the methods described herein possess a significantly higher adhesion strength to surface coatings such as, for example, metal coatings when compared to substrates texturized by conventional techniques such grit blasting. Not wishing to be bound by theory, the unique surface morphology and structural features of the microtexturized substrates produced herein result in significantly increased adhesion to coatings when applied to the microtexturized surface.

It is desirable in certain applications to prepare coated substrates that have strong and prolonged adhesion to the substrate. For example, metal substrates coated with metal powders by thermal spray or cold spray processes are used in a number of different articles such as, for example, an airfoil, a turbine bucket, an exhaust manifold, a flue gas system or a component of a flue gas system, a fly ash system or a component of a fly ash system, another aircraft component, or a component of a ship, submarine, or bridge. In one aspect, the coating when applied to the microtexturized substrates produced herein has an adhesion strength of from about 1 MPa to about 10,000 MPa as measured by ASTM C633, or about 1 MPa, 25 MPa, 50 MPa, 100 MPa, 500 MPa, 1,000 MPa, 2,000 MPa, 3,000 MPa, 4,000 MPa, 5,000 MPa, 6,000 MPa, 7,000 MPa, 8,000 MPa, 9,000 MPa, or 10,000 MPa, where any value can be a lower and upper endpoint of a range (e.g., 25 MPa to 500 MPa).

### Aspects

Aspect 1. A method for producing a microtextured surface on a substrate, the method comprising subjecting the surface of the substrate to a pulsed laser across the substrate at a controlled overlap of each pulsed laser to produce the microtextured surface.

Aspect 2. The method of Aspect 1, wherein the method creates a plurality of features having an average height of about 0.1 μm to about 50 μm across the surface microtextured of the substrate and the average spacing between each of the features is from about 0.1 μm to about 50 μm.

Aspect 3. The method of Aspect 1 or 2, wherein the substrate comprises a metal, ceramic, polymer, composite, alloy, or glass.

Aspect 4. The method of Aspect 1 or 2, wherein the substrate comprises aluminum, copper, nickel, iron, or an alloy thereof.

Aspect 5. The method of Aspect 1 or 2, wherein the substrate comprises aluminum or an aluminum alloy.

Aspect 6. The method of any one of Aspects 1-5, wherein the surface of the substrate is polished to a surface roughness of less than 1 μm prior to subjecting the surface of the substrate to the pulsed laser.

Aspect 7. The method of any one of Aspects 1-5, wherein the surface of the substrate roughness of has a 0.01 μm to 20 μm prior to microtexturizing.

Aspect 8. The method of any one of Aspects 1-7, wherein the pulsed laser is produced by an ytterbium fiber laser.

Aspect 9. The method of any one of Aspects 1-8, wherein the pulsed laser has a wavelength range of about 250 nm to about 11,000 nm.

Aspect 10. The method of any one of Aspects 1-9, wherein the pulsed laser has an average power of about 1 W to about 1,000 W.

Aspect 11. The method of any one of Aspects 1-10, wherein the pulsed laser has a pulse frequency range of about 1 Hz to about 100 MHz.

Aspect 12. The method of any one of Aspects 1-11, wherein the pulsed laser has a pulse energy of from about 1 μJ to about 100 J.

Aspect 13. The method of any one of Aspects 1-12, wherein the pulsed laser has a diameter in the range of about 1 μm to about 100 mm.

Aspect 14. The method of any one of Aspects 1-13, wherein the surface of the substrate is subjected to the pulsed laser at a scanning rate of from about 0.1 mm/s to about 10,000 mm/s.

Aspect 15. The method of any one of Aspects 1-14, wherein the overlap between each pulsed laser along a direction of scanning is from about 0% to about 99.5%.

Aspect 16. The method of any one of Aspects 1-14, wherein the overlap between each pulsed laser along a direction of scanning is from about 0% to about 99.5%.

Aspect 17. The method of any one of Aspects 1-16, further comprising blowing air or inert gas over the surface of the substrate during microtexturizing.

Aspect 18. The method of Aspect 17, wherein the inert gas comprises nitrogen, argon, or a combination thereof.

Aspect 19. The method of any one of Aspects 1-18, wherein the pulsed laser is applied to the surface of the substrate using a galvanometer.

Aspect 20. The method of any one of Aspects 1-19, wherein the pulsed laser is mounted on a translational stage.

Aspect 21. A substrate produced by the method of any one of Aspects 1-20.

Aspect 22. The substrate of Aspect 21, wherein the substrate has a surface energy of from about 1 mN/m to about 2,000 mN/m.

Aspect 23. The substrate of Aspect 21 or 22, wherein the substrate has a water contact angle of from about 1° to about 175°.

Aspect 24. A substrate comprising at least one microtexturized surface and a coating comprising a metal powder in contact with the microtexturized surface.

Aspect 25. The substrate of Aspect 24, wherein the microtexturized surface is produced by the method of any one of Aspects 1-20.

Aspect 26. The substrate of Aspect 24 or 25, wherein the metal powder has a particle size of from about 0.1 μm to about 500 μm.

Aspect 27. The substrate of any one of Aspects 24-26, wherein the metal powder comprises a metal alloy.

Aspect 28. The substrate of any one of Aspects 24-27, wherein the metal powder comprises CoNiCrAlY.

Aspect 29. The substrate of any one of Aspects 24-28, wherein the metal powder is applied to the at least one microtexturized surface by a thermal spray process.

Aspect 30. The substrate of any one of Aspects 24-29, wherein the coating has an adhesion strength from about 1 MPa to about 10,000 MPa as measured by ASTM C633.

Aspect 31. An article comprising the substrate of any one of Aspects 24-30.

Aspect 32. The article of Aspect 31, wherein the article comprises an airfoil, a turbine bucket, an exhaust manifold, a flue gas system or a component of a flue gas system, a fly ash system or a component of a fly ash system, another aircraft component, or a component of a ship, submarine, or bridge.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### EXAMPLES

The following examples are put forth so as to provide those of ordinary skill in the art with a complete disclosure and description of how the compounds, compositions, articles, devices and/or methods claimed herein are made and evaluated and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1: Materials and Methods

### Materials

The substrates used were aluminum (Al 7075) micromachined buttons (diameter=1 inch; thickness—0.5 inches) polished down to roughness of less than 1 μm. The chemical composition of Al 7075 was Zn=5.4%, Cu=1.42%, Mn=0.12%, Mg=2.42%, Fe=0.42%, Cr=0.21%, Ti=0.11%, Si=0.13%, and Al=89.77% (see Table 1), by weight. Al 7075 has a high strength to low weight ratio, excellent wear resistance and provides high-temperature corrosion protection. It is widely used in the aircraft and automotive industries. The coating powders used for the thermal spray process were Oerlikon Metco Amdry 995C (CoNiCrAlY) and Oerlikon Metco Amdry 9951 (Co[Ni]CrAlY)). CoNiCrAlY powders are usually used for bond coats. The mean particle sizes of the powders were 90 μm and 38 μm, respectively. The different particle sizes were chosen to demonstrate the effect of particle granulometry on surface morphology.

TABLE 1
Al 7075 Alloy Composition

| Element | Wt % |
|---|---|
| Al | 89.77 |
| Zn | 5.4 |
| Mg | 2.42 |
| Cu | 1.42 |
| Fe | 0.42 |
| Cr | 0.21 |
| Si | 0.13 |
| Mn | 0.12 |

### Laser Microtexturing

The laser used in these experiments was a 532 nm wavelength, 10 W average power ytterbium fiber laser (YLP-G-10, IPG Photonics) with 1.3 ns pulse duration, and 20.2 μJ pulse energy at 600 kHz, and has a Gaussian beam profile. The galvanometer scan head used was a SCANcube 14, SCANLAB, with a scan pattern designed in EZCad (Beijing JCZ Technology Co. Ltd). The laser repetition rate was varied from 400 kHz to 600 kHz, and a focused laser beam with a full-width half-maximum (FWHM) size of 20 μm was used. The laser fluence used for the experiments were 0.76 J/cm², 0.92 J/cm², and 0.8 J/cm². The laser beam scan speed was maintained at 60 mm/s. For each laser fluence, the side-to-side overlap between the lines was 50%. The overlap between the laser spots along the direction of scanning was 99.25% and 99.5% at 400 kHz and 600 kHz, respectively. A galvanometer (SCANLAB SCANcube 14) controlled by a custom LabVIEW program was used to perform the raster scan of the aluminum surface. This enabled us to achieve consistent microtexture patterns throughout the sample. Nitrogen gas was blown over the sample during laser microtexturing to prevent oxidation. A schematic diagram of the experimental setup is shown in FIG. 1. The different laser parameters used in the microtexturing process are shown in Table 2.

TABLE 2
Laser Processing Parameters^{a}

| Pattern Index^{b} | Frequency (kHz) | Fluence (J/cm²) |
|---|---|---|
| Line #1 | 400 | 0.76 |
| Line #2 | 400 | 0.92 |
| Line #3 | 600 | 0.80 |

^{a}Laser wavelength = 532 nm, scan speed = 60 mm/s, number of scans = 1.
^{b}Line #1, Line #2, and Line #3 indicate the use of different process parameters.

FIGS. 2A-2F show the variation of the surface morphology with changing laser fluences. It can be seen that at higher fluences, the ablation is much more significant than at lower ones. The fluence at which the laser starts to make features on the surface is between 0.38 J/cm² to 0.45 J/cm².

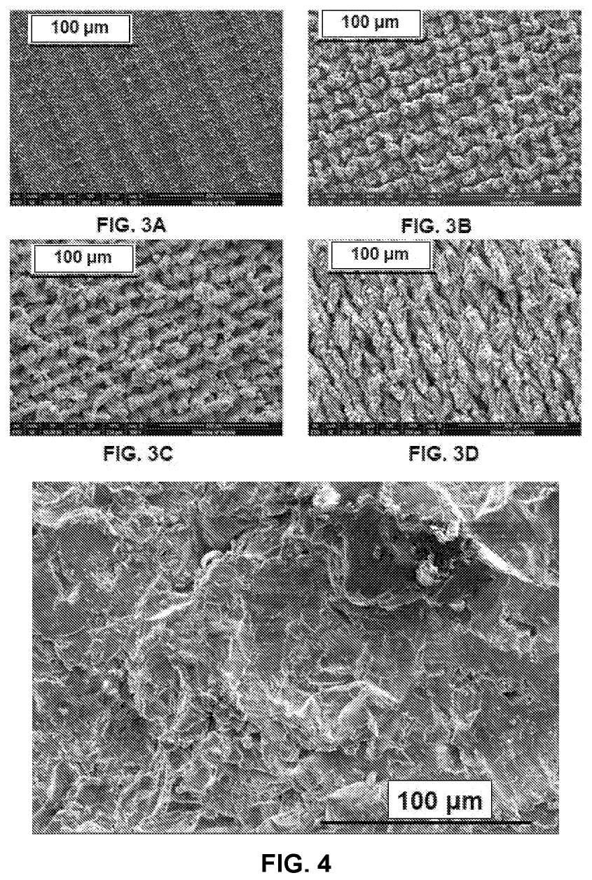

FIGS. 3A-3D show the variation of the surface morphology with changing laser repetition rate (frequency). At lower frequency, the number of laser pulses per unit area is significantly less than that at a higher frequency. Hence, the laser digs out more material from the surface at higher frequencies compared to lower ones. As can be seen, the surface seems much more ablated and roughened at higher frequencies.

### Grit-Blasting

The thermal spray coating samples were also fabricated on grit-blasted samples. For this process, the samples were secured to a plate using double-sided tape to ensure they remained stationary during abrasive blasting. The nozzle was manually rastered over the samples using the nominal parameters shown in Table 3. Thereafter, compressed air was blasted on the samples to remove any residual dust. Then, the sample surface was cleaned with ethanol. The surface of a grit-blasted sample is shown in FIG. 4.

TABLE 3
Grit-Blasting Parameters

| Blast Media | Alumina (~50 μm particle size) | |
|---|---|---|
| Pressure | 0.28 | Mpa |
| Nozzle distance | ~140 | mm |
| Angle | 70° | |
| Traverse speed | 1000 | mm/sec |
| Step distance | 10 | mm |

| | |
|---|---|
| Passes | 2 orthogonal passes |

### Thermal Spray Process

The grit-blasted and the laser microtextured samples were coated with metal powders by atmospheric plasma spray (APS) using an Oerlikon Metco F4 MB-XL plasma gun attached to a 6-axis robotic arm. The first step of this process involves cleaning the grit-blasted and laser microtextured samples with compressed air. This is followed by attaching the samples to vertical fixtures. Thereafter, the thermal spray gun is turned on and passed over the substrate in a rectangular raster pattern. Prior to applying the powder, a pre-heat pass was executed in order to elevate the substrate temperature to 100° C., and the powder feed was allowed to stabilize for 1-2 minutes prior to deposition. Table 4 provides the different APS parameters used in this study.

TABLE 4
Deposition Parameters for Thermal Spray
for Amdry 9951 and 995C Powders

| APS Parameters | Amdry 9951 | Amdry 995C |
|---|---|---|
| Carrier gas flow | Argon | Argon |
| Carrier gas flow rate (nlpm) | 4.5 | 3.5 |
| Powder feeding rate (g/min) | 60.5 | 60.1 |
| Spray distance (mm) | 120 | 120 |
| Number of passes | 10 | 10 |
| Surface speed (mm/s) | 1250 | 1250 |
| Plasma temperature (° C.) | 2922 | 2612 |
| Particle velocity (m/s) | 210 | 166 |
| Gun current (A) | 600 | 600 |
| Primary gas type | Argon | Argon |
| Primary gas flow rate (nlpm) | 56.8 | 56.9 |
| Secondary gas type | Hydrogen | Hydrogen |
| Secondary gas flow rate (nlpm) | 8.5 | 57 |
| Injector standoff distance (mm) | 6 | 6 |
| Water flow rate (lpm) | 15.6 | 15.7 |

### Coating Adhesion Testing and Coating Failure Analysis

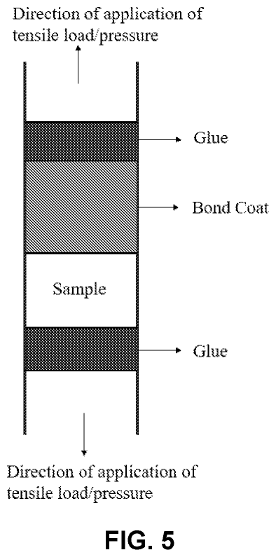

The coated samples were subjected to tensile adhesion testing, where the tensile pressure required to rupture the surface of the coatings was measured. This was done following the ASTM C633 standard using an Instron C633 mechanical analyzer. As shown in FIG. 5, the cylindrical sample was glued between two cylindrical rods. The load was applied in the direction perpendicular to the interface between the coating and the substrate. The tensile load was gradually increased until the coating was ruptured or pulled out from the substrate. The glue used in the process was Polyamide-epoxy FM 1000 Adhesive Film. The adhesion strength was calculated as the load at sample failure divided by the coating area.

### Surface Morphology and Chemical Composition Characterization

The surface morphology and elemental analysis were done using FEI Quanta 650 Field Emission SEM. 3D optical profile measurements were done using Olympus LEXT OLS4000 3D Laser Microscope to understand the variation in the texture heights, the peak-to-valley spacing, and the density and uniformity of the features. After deposition of the coating, the cross-sectional morphology characterization and EDS analysis were also performed using the FEI Quanta 650 Field Emission SEM.

### Example 2: Results

The laser microtexturing process reported in scientific literature has been performed by laser ablation of materials, and it is done by drawing orthogonal lines. Laser ablation methods do not provide a fully microtextured area, and hence, it leads to lower coating adhesion strength. The method presented in this paper is based on selecting the laser power in such a way that it offers melting combined with some ablation. The thermomechanical rearrangement of the molten material accompanied by small ablation gives dense, and uniform features across the entire surface. This approach provides a large increase in the surface area, leading to enhanced bonding strength of thermal spray coatings.

### Surface Morphology

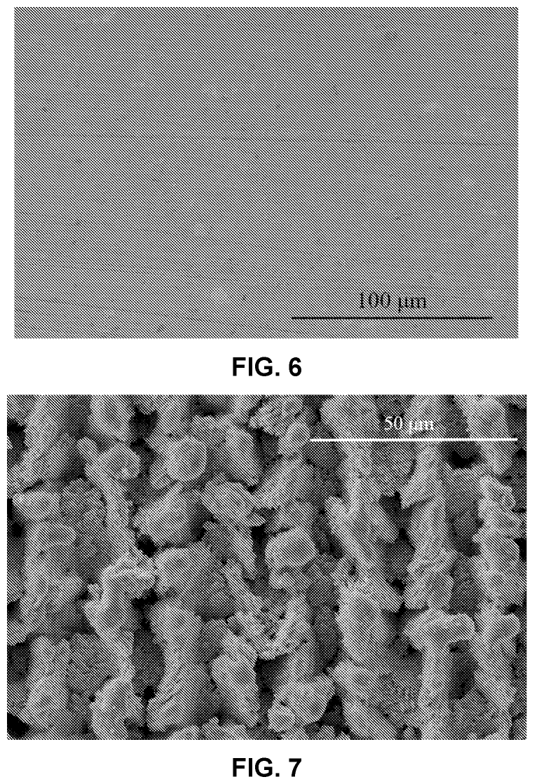

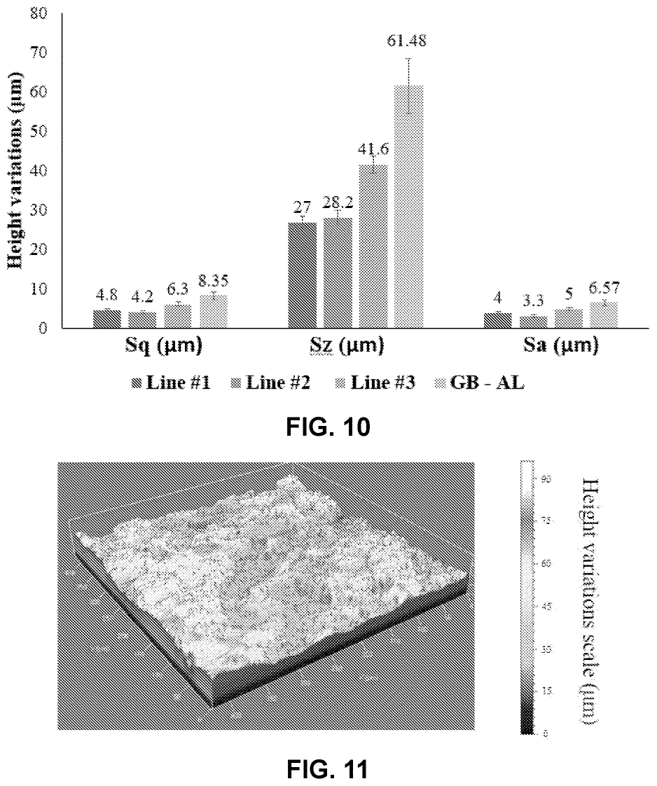

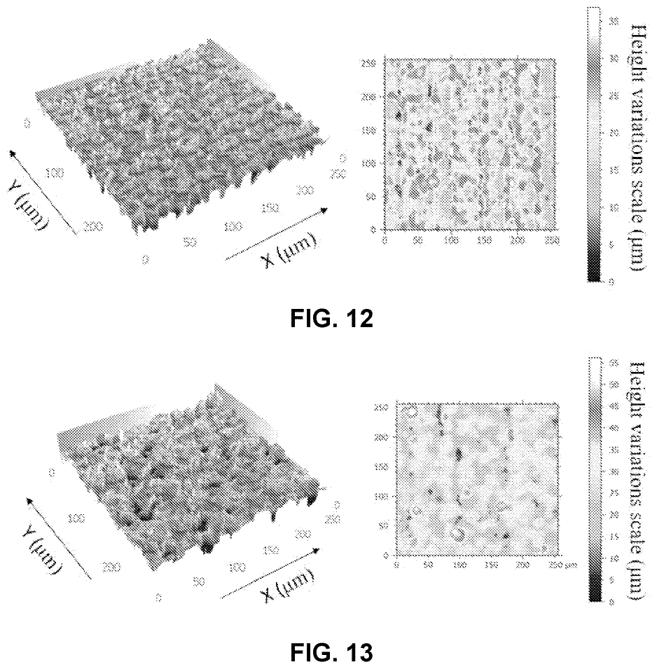

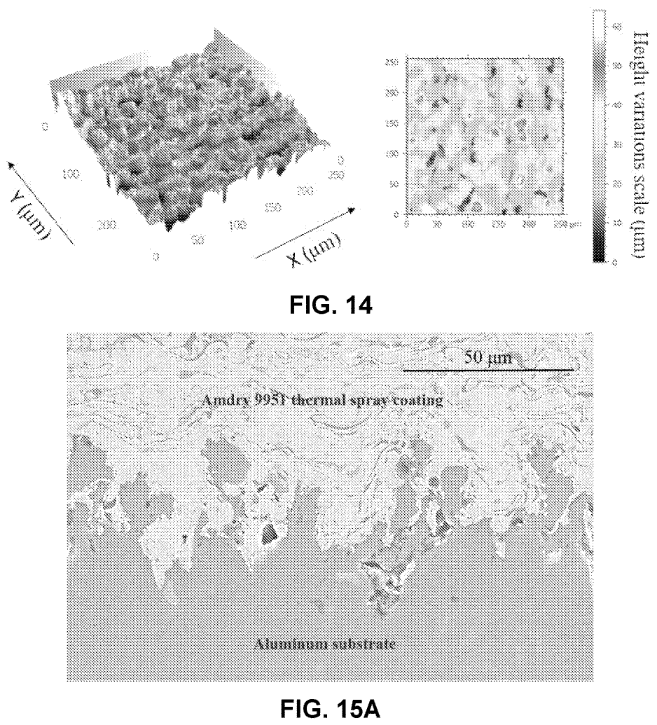

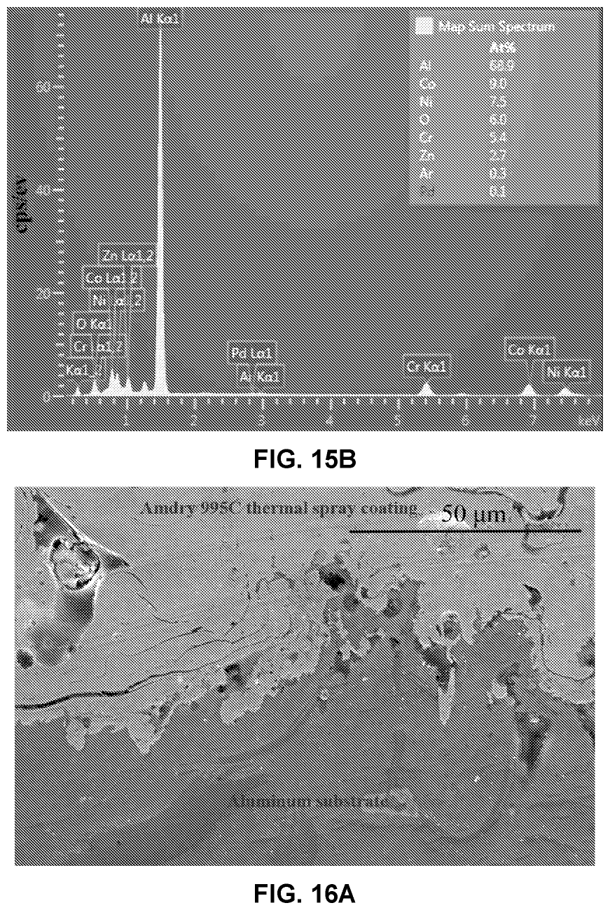

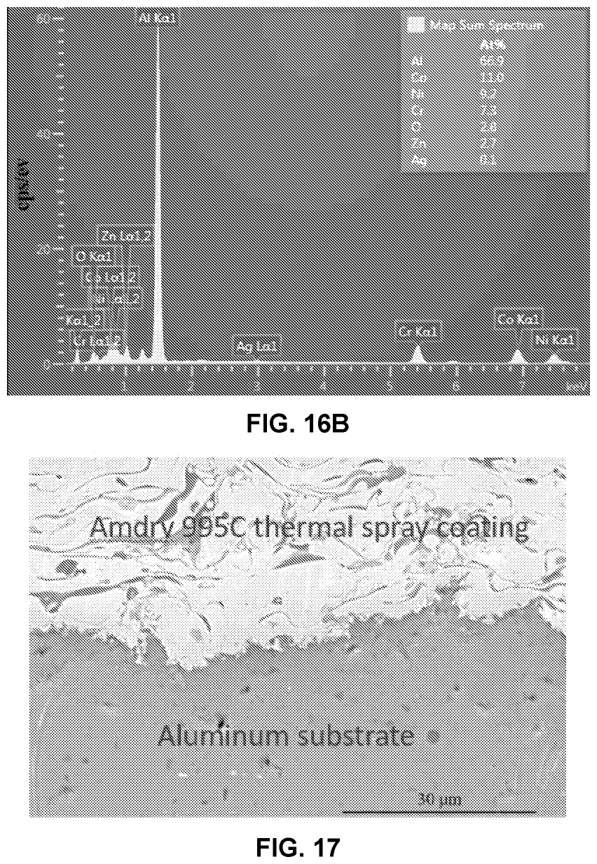

As a point of reference, FIG. 6 shows the surface of a plane untextured aluminum sample. FIGS. 7-9 show the different laser surface microtextured patterns. It can be seen that pillar like structures have been formed on the surface with periodic grooves. The thermally sprayed molten powders settle into the grooves and thus provides interlocking. The surface shown in FIG. 9 was obtained with the highest number of pulses per unit area compared to the other two surfaces. The three laser microtextured patterns were chosen in such a way that it captures a range of variations in feature height and spacing between the peaks. Looking at the morphology, some droplet formation appears to occur which indicates melting and resolidification, along with ablation. FIG. 10 provides an idea of the pattern height variations. The average height for the laser microtextured features was around 5 μm which is much less than the surface feature height of 6.5 μm for grit-blasted surfaces. There are considerable height variations on the laser textured and grit-blasted samples with maximum heights reaching up to 27 μm, 28.2 μm, 41.6 μm, and 61.48 μm for line #1, line #2, line #3, and line #4 respectively. FIG. 11 shows the surface variation of a grit-blasted aluminum sample. It can be observed that there is no periodicity in the features formed on the surface. FIGS. 12-14 provide a detailed surface profile for the three laser microtexture patterns shown in FIGS. 7-9. The 2D map shows the differences in height and density of the features across the surface, while the 3D map gives a more thorough visualization of the distribution of the features. It can also be observed that line #2 has higher peaks than that of line #1, and line #3 has higher peaks than both line #1 and line #2. This can be attributed to the fact that line #3 had the highest number of laser pulses per unit area, and line #2 had more fluence than of line #1. The average distance between the peaks in all the laser microtextured patterns was 5 μm. The cross-sectional interface morphology and the elemental composition are illustrated in FIGS. 15A-16B. FIG. 17 shows the cross-sectional interface morphology of the grit-blasted sample and Amdry 995C. It can be seen that the coating of the grit-blasted sample has much less infiltration than that of the laser textured surfaces. The average thickness of the coating was found to be around 275 μm. The EDS spectra in FIGS. 15B and 16B show the oxygen concentration at both the interfaces of Amdry 995C and 9951.

### Wettability and Surface Energy Study

The water wettability and the surface energy of the laser microtextured surfaces were investigated using contact angle measurements. The measurements were done using a Ramè-hart Goniometer model 250. The surface energy of the aluminum was measured to be 852.46±0.95 mN/m. The untextured aluminum surface was found to be mildly hydrophilic with water contact angles (CA) of 81°±6°. On the other hand, the laser microtextured aluminum surfaces were found to be highly hydrophilic, exhibiting water contact angles of 25°±8°. This behavior can be explained by the fact that the water contact angle on a flat hydrophilic surface decreases with an increase in surface area, as expressed by Wenzel's equation

$$Cos {Θ}_{r} = r cos {Θ}_{f}$$

where Θ_{f} is the contact angle of water on an ideally smooth flat surface; Θᵣ is the contact angle of water on a rough surface with r as the roughness parameter (r=1 for smooth surfaces and r>1 for rough surfaces).

### Failure Analysis

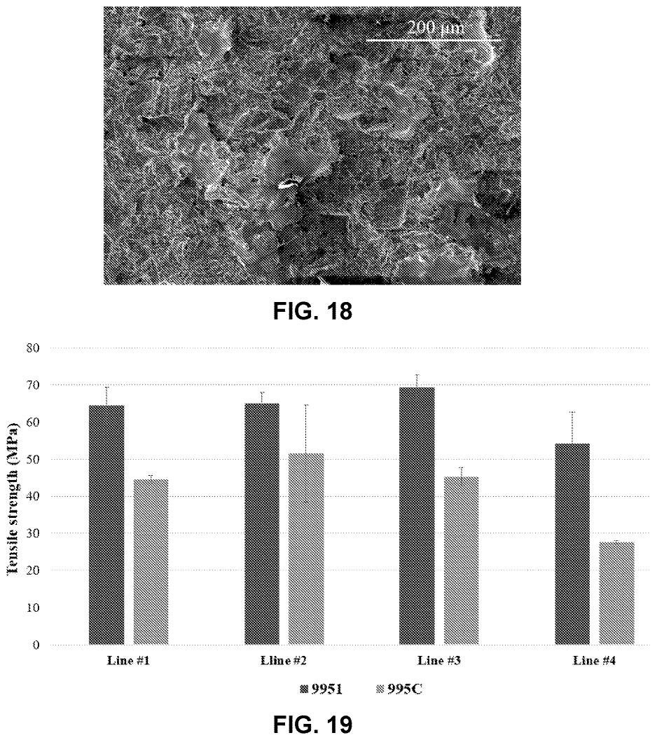

FIG. 18 shows the thermally sprayed surface coating on the grit-blasted aluminum sample after the tensile adhesion test has been performed. Delamination can be observed across the surface of the ruptured coating in the case of the grit-blasted sample. The grit-blasted sample displayed cohesive failure at the epoxy-coating interface as well as adhesive failure, while the laser microtextured sample displayed only cohesive failure at the epoxy-coating interface at the sample pull-off pressure.

### Adhesion Strength Measurement Results

We obtained significantly higher tensile adhesive strength for laser microtextured surfaces compared to those reported in previous laser microtexturing research studies. These results are shown in FIG. 19. Four samples were tested for each of the laser microtexturing and grit-blasting to obtain the adhesion data and associated error bars. Of the three laser patterns used, line #3 gave taller surface features as the laser frequency used was relatively more than that of the other two patterns. Increasing laser frequency results in a greater number of pulses per unit area. The laser microtextured patterns in this study were also significantly denser than that reported in previous literature, as the laser was used to scan the surface area of the samples in its entirety. Thus, it can be proven that densely packed features are beneficial in increasing the bonding strength. Line #1 and line #2 had almost identical average feature height even though line #2 was scanned with a little bit more fluence.

### Example 3: Discussion and Conclusion

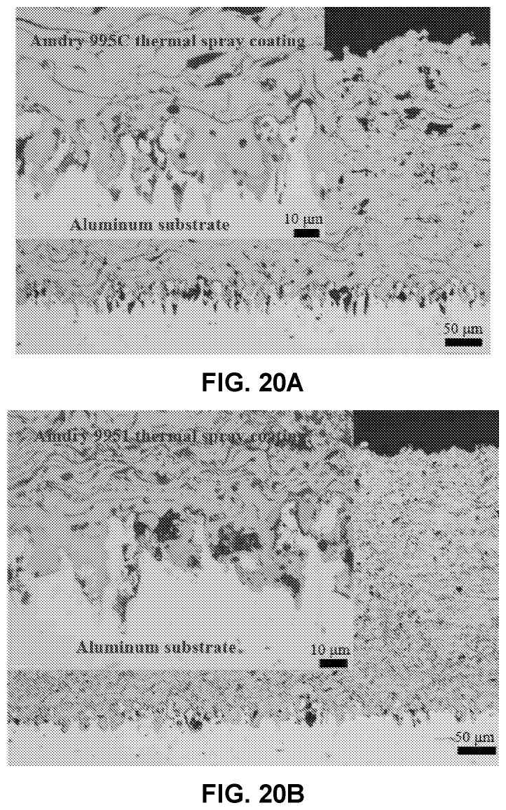

The features on the surface that are formed by melting, ablation and resolidication of the materials are affected by the different laser parameters like fluence, pulse-width, speed, frequency, etc. The increase in frequency leads to increased pulses per unit surface area. This gives rise to deeper surface features, increased surface area, and hence, increased adhesion of the coating. The depth and density of the features can be controlled by the changing the fluence and frequency of the laser. Moreover, higher power results in ablation of more surface materials which leads to the formation of more particles. These particles can settle down and resolidify on top of the surface “pillars” providing nanoscale roughness which can further increase adhesion of the coating. Feature height needs to be chosen so that the microtexture is stable under APS processing. It should be noted that for all the laser microtextured and even the grit-blasted surfaces, the adhesion strength of Amdry 9951 powder is more than that of Amdry 995C powder. This is because the mean particle size of Amdry 9951 powder is much smaller compared to Amdry 995C powder. This allows for increased infiltration of the molten droplets, thereby providing more tensile adhesive strength, as shown in FIGS. 20A-20B. Optimizing coating-substrate adhesion requires adaptation of the powder size to the surface topography in order to achieve a superior surface filling ratio. The average laser formed feature height in this work was around 5 μm compared to feature depths of 80-180 μm reported in previous laser studies. Hence, the throughput of the fully textured laser method is higher, and the associated cost is much lower.

The mechanism behind the formation of the pulsed laser-induced micropillars can be explained by ripple-like structures formed during the early stages of the microstructure evolution. Interference between the incident and the scattered laser light at the surface, heat-mass transfer, and hydrodynamic and plasmonic effects are the possible reasons behind the creation of the ripples. These ripples are broken down gradually as the microstructure develops, giving rise to the micropillars. The breaking down of the ripples can be attributed to molten material expansion and sputtering caused by the recoil pressure of the laser-matter interaction. The expelled molten material drops cool down drastically as soon as it leaves the laser-irradiated area. The effect of the recoil pressure on the molten material ceases to exist as the surface temperature drops below the vaporization point at the end of the laser pulse. Finally, gravitational forces and surface tension make the molten material settle back down on the surface.

The influence of the laser power density on the melt depth can be obtained by solving a one-dimensional heat conduction problem in the liquid and solid regions of the laser-irradiated area. The penetration depth X(t) can be expressed as a function of the laser power density/and irradiation time t as follows:

$$X ( \text{?} ) = {[ - \frac{{b}_{\text{?}}}{2} + {( \frac{{b}_{\text{?}}^{2}}{4} + \frac{{a}_{\text{?}}^{3}}{27} )}^{1 / 2} ]}^{1 / 3} + {[ - \frac{{b}_{\text{?}}}{2} - {( \frac{{b}_{\text{?}}^{2}}{4} + \frac{{a}_{\text{?}}^{3}}{27} )}^{1 / 2} ]}^{1 / 3} - \frac{{α}_{\text{?}} {m}_{\text{?}}}{16 A \text{?}}$$

$$where$$

$${a}_{0} = \frac{3 {α}_{\text{?}}^{2} {m}_{s}^{2}}{256 {( A \text{?} )}^{2}} ( \frac{192 {( A \text{?} )}^{2} t}{{α}_{\text{?}} {m}_{s}^{2}} + 31 )$$

$${b}_{\text{?}} = - \frac{{α}_{\text{?}}}{8 A \text{?}} [ \frac{{α}_{l}^{2} {m}_{\text{?}}^{2}}{256 {( A \text{?} )}^{2}} ( \frac{288 {( A \text{?} )}^{2} t}{{α}_{\text{?}} {m}_{\text{?}}^{2}} + 47 ) + \frac{t ( 18 {( A \text{?} )}^{2} t + 3 {α}_{\text{?}}^{2} {m}_{\text{?}}^{2} )}{{m}_{\text{?}}} ]$$

$${m}_{\text{?}} = ρ [ {c}_{p} ( {T}_{m} - {T}_{0} ) + L ]$$

$$\text{?} \text{indicates text missing or illegible when filed}$$

Here αₗ is the thermal diffusivity in the liquid phase; Tₘ is the melting point; ρ is the density; cₚ is the specific heat of materials in a solid phase; A is the absorptivity of materials; L is the latent heat of fusion; and T₀ is the initial temperature.

Furthermore, the temperature profile Tₛ(x,t) in the solid metal region and the temperature distribution Tₗ(x,t) in the liquid region is given as follows:

$${T}_{\text{?}} ( x , \text{?} ) = {T}_{\text{?}} - ( {T}_{\text{?}} - {T}_{0} ) \{ 1 - exp [ - \frac{1}{{α}_{\text{?}}} \frac{dX ( \text{?} )}{dt} ( x - X ( \text{?} ) ) ] \} , X ( \text{?} ) \leq x < ∞$$

$${T}_{\text{?}} ( x , \text{?} ) = {T}_{\text{?}} - \frac{A \text{?}}{{k}_{\text{?}}} [ x - X ( \text{?} ) ] + \frac{A \text{?}}{2 {\text{?}}_{\text{?}} {k}_{\text{?}} [ 1 + \frac{X \text{?}}{\text{?}} \frac{dX}{\text{?}} ]} \times \frac{dX ( \text{?} )}{d \text{?}} [ {x}^{2} - {X}^{2} ( \text{?} ) ] , 0 \leq x \leq X ( \text{?} )$$

$$\text{?} \text{indicates text missing or illegible when filed}$$

where x is the distance from the surface of the substrate; kₗ is the thermal conductivity in the liquid phase; αₛ is the thermal diffusivity in the solid phase; and Al is the absorbed laser power density.

The influence of the laser power density on the melt depth can be obtained by solving a one-dimensional heat conduction problem in the liquid and solid regions of the laser-irradiated area.

It should be noted that for all the laser microtextured and even the grit-blasted surfaces, the adhesion strength of Amdry 9951 powder is more than that of Amdry 995C powder. This is because the mean particle size of Amdry 9951 powder is much smaller, compared to Amdry 995C powder. This allows for increased infiltration of the molten particles into the laser-generated microtexture, thereby pro-viding more tensile adhesive strength, as shown in FIG. 18. Optimizing coating-substrate adhesion requires adaptation of the powder size to the surface topography to achieve a superior surface filling ratio [9]. The average laser-formed feature height in this work was around 5 μm, compared to feature depths of 80-180 μm reported in previous laser studies [6, 7]. Hence, the throughput of the full-area laser micro-texturing method is higher, and the associated cost will be much lower.

Compared to grit-blasting which only provides macroscale roughness, the fully microtextured laser method provides superior control and micro-scale roughness. The maximum adhesion strength reported for thermally sprayed Amdry 9951 (CoNiCrAlY) bond coat to laser textured surface is around 53 MPa. This value is comparable to that of the grit-blasted samples reported in the scientific literature and in this paper which is around 55 MPa. The maximum reported adhesion strength of bond coat to laser microtextured samples reported in this paper is around 65 MPa which is an increase of around 18%. Some of the other potential applications of thermal spray coatings include oxidation and hot corrosion resistance of airfoils, turbine buckets, ceramic clearance control coatings, exhaust manifolds, flue gas, and fly ash systems. So, the method of surface mictrotexturing presented in this paper could have a wide range of varied applications in improving adhesion strength of thermally sprayed coatings on other metals and alloys as well.

Some of the other potential applications of improved adhesion strength thermal spray coatings include oxidation and hot corrosion resistance of airfoils, turbine buckets, ceramic clearance control coatings, exhaust manifolds, flue gas, and fly ash systems. So, the method of surface mictrotexturing presented in this paper could have a wide range of varied applications in improving the adhesion strength of thermally sprayed coatings on other metals and alloys.

### CONCLUSION

Herein is demonstrated a novel method for laser microtexturing through, for example but not limited thereto, a thermomechanical process of creating dense, uniform groove-like features for coating adhesion improvements. The entirety of the area of the surfaces was microtextured, and this leads to an increase in the total surface area compared to the untextured surface area. This contributes to a substantial increase in the atmospheric plasma sprayed coating bond strength compared to untextured, grit-blasted, and other laser microtextured surfaces as reported in the literature. The results of laser microtexturing parameter's effect on surface morphology and cross-section of thermal spray coating on laser microtextured surfaces are presented to provide an understanding of adhesion strength improvements.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### REFERENCES

1. ASM Thermal Spray Society (TSS), Accepted Practice to Test Bond Strength of Thermal Spray Coatings. <https://www.asminternational.org/documents/17679604/17683439/AcceptedPracticeBondS trengthApprovedformatted_Intro.pdf/4bcf5903-414d-413f-ab69-7cf0cc9123bd> (accessed 24 Aug. 2021).
2. Bagade, V U, et al, “Effect of Laser Surface Texturing on Coating Adherence and Tribological Properties of CuNiIn and MoS2 Coating,” Trans. Indian Inst. Met., 75 239-250 (2022)
3. Chakraborty, A, et al, “Superhydrophobic Surfaces by Microtexturing: A Critical Review,” Rev. Adhes., 9 (1) 35-64 (2021)
4. Ciecińska, B, “Laser Beam Surface Pretreatment for the Adhesive Bond Strength Improvement,” Strength Mater., 48 561-565 (2016)
5. Crespo, V, et al, “The Influence of Feedstock Powders on the CGS Deposition Efficiency of Bond Coats for TBCs,” J. Alloys Compd., 622 394-401 (2015)
6. Critchlow, G W, et al, “Review of Surface Pretreatments for Aluminum Alloys,” Int. J. Adhes. Adhes., 16 (4) 255-275 (1996)
7. Devaneyan, S P, et al, “On the Mechanical Properties of Hybrid Aluminum 7075 Matrix Composite Material Reinforced with SiC and TiC Produced by Powder Metallurgy Method,” Indian J. Mater. Sci., 2017 128-135 (2017)
8. Garcia-Alonso, D, et al, “Pre-/During-/Post-Laser Processes to Enhance the Adhesion and Mechanical Properties of Thermal-sprayed Coatings with a Reduced Environmental Impact,”, J. Therm. Spray Tech., 20 719-735 (2011)
9. Gupta, M. et al “METHOD OF FORMING A SPECTRAL SELECTIVE COATING”, U.S. Pat. No. 10,201,947, Feb. 12, 2019.
10. Gupta, M. C. et al “Conducting Nanotubes or Nanostructures Based Composites, Method of Making Them and Applications”, U.S. Pat. No. 8,424,200, Apr. 23, 2013.
11. Gupta, M. C. et al “Conducting Nanotubes or Nanostructures Based Composites, Method of Making Them and Applications”, WO 2008/045109, Apr. 17, 2008.
12. Gupta, M. C. et al “Micro-Structure and Nano-Structure Replication Methods and Article of Manufacture”, U.S. Pat. No. 10,131,086, Nov. 20, 2018.
13. Gupta, M. C. et al “Systems and Methods of Laser Texturing and Crystallization of Material Surfaces”, U.S. Pat. No. 8,753,990, Jun. 17, 2014.
14. Gupta, M. C. et al “Systems and Methods of Laser Texturing of Material Surfaces and their Applications”, US Publication No. 2010/0143744, Jun. 10, 2010.
15. Gupta, M. C. et al “Systems and Methods of Laser Texturing of Material Surfaces and their Applications”, WO 2008/127807, Oct. 23, 2008.
16. Gupta, M. C. et al, “Systems and Methods of Laser Texturing and Crystallization of Material Surfaces”, WO 2008/091242, Jul. 31, 2008.
17. Gupta, M. C. et al, “SYSTEMS AND METHODS OF LASER TEXTURING OF MATERIAL SURFACES AND THEIR APPLICATIONS”, U.S. Pat. No. 8,846,551, Sep. 30, 2014.
18. Gupta, M. C. et al. “Systems and Methods of Laser Texturing and Crystallization of Material Surfaces”, US Publication No. 2014/0273535, Sep. 18, 2014.
19. Gupta, M. C. et al., “COMPOSITION AND METHOD FOR A MICROTEXTURE HYDROPHOBIC OR SUPERHYDROPHOBIC COATING”, US Publication 2021/0154700 A1, May 27, 2021.
20. Gupta, M C, et al, “Diode Pumped Solid State Lasers for Surface Microtexture,” J. Laser Micro/Nanoengineering, 8 (2) 124-130 (2013)
21. Kadleckova, M, et al, “Preparation of Textured Surface on Aluminium-alloy Substrates.” Materials (Basel), 12 (1) 109-120 (2018)
22. Karaoglanli, A C, et al, “Effects of Heat Treatment on Adhesion Strength of Thermal Barrier Coating Systems,” Engineering Failure Analysis, 32 16-22 (2013).
23. Kromer, R, et al, “Coating Deposition and Adhesion Enhancements by Laser Surface Texturing—Metallic Particles on Different Classes of Substrates in Cold Spraying Process,” Mater. Manuf. Process., 32 (14) 1642-1652 (2017)
24. Kromer, R, et al, “Cold Gas-sprayed Deposition of Metallic Coatings onto Ceramic Substrates using Laser Surface Texturing Pre-treatment,” J. Therm. Spray. Tech., 27 809-817 (2018)
25. Kromer, R, et al, “Control of the Mesostructured of Suspension Plasma-sprayed Coating with Laser Surface Texturing: Application to TBC,” J. Therm. Spray Tech., 28 405-416 (2019)
26. Kromer, R, et al, “Laser Patterning Pretreatment Before Thermal Spraying: A Technique to Adapt and Control the Surface Topography to Thermomechanical Loading and Materials,” J. Therm. Spray Tech., 25 (3) 401-410 (2016)
27. Kromer, R, et al, “Laser Surface Patterning to Enhance Adhesion of Plasma Sprayed Coatings,” Surf. Coat. Tech., 278 171-182 (2015)
28. Kromer, R, et al, “Laser Surface Texturing to Enhance Adhesion Bond Strength of Spray Coatings—Cold spraying, Wire-arc Spraying, and Atmospheric Plasma Spraying,” Surf. Coat. Tech., 352 642-653 (2018)
29. Kromer, R, et al, “Role of Powder Granulometry and Substrate Topography in Adhesion Strength of Thermal Spray Coatings,” J. Therm. Spray Tech., 25 933-945 (2016)
30. Lambiase F, et al (2022) Recent advances in metal-polymer joining processes. In Rakesh P, Davim P (ed) Mechanical engineering series, joining processes for dissimilar and advanced materials, 3rd edn. Woodhead Publishing Reviews: Mechanical Engineering Series, pp 123-151
31. Lamraoui, A, et al, “Laser Surface Texturing (LST) treatment before Thermal Spraying: A New Process to Improve the Substrate-coating Adherence,” Surf. Coat. Tech., 205 (1) 164-167 (2010)
32. Lima, C R C, et al, “Adhesion Improvements of Thermal Barrier Coatings with HVOF Thermally Sprayed Bond Coats,” Surf. Coat. Tech., 201 (8) 4694-4701 (2007)
33. Long, J, et al, “Formation Mechanism of Hierarchical Micro- and Nanostructures on Copper Induced by Low-cost Nanosecond Lasers,” Appl. Surf. Sci., 464 412-421 (2019)
34. Lyphout, C, et al, “Relationships between Process Parameters, Microstructure, and Adhesion Strength of HVOF Sprayed IN718 Coatings,” J. Therm. Tech., 20 76-82 (2011)
35. Madry K, et al (2021) Wetting between Cassie-Baxter and Wenzel regimes: a cellular model approach. Eur Phys J E 44:138-149.
36. Maressa, P, et al, “Effect of Surface Texture on the Adhesion Performance of Laser Treated Ti6Al4V Alloy,” J. Adhes., 91 (7) 518-537 (2015)
37. Mulroney, A T, et al, “Optically Transparent Superhydrophobic Polydimethylsiloxane by Periodic Surface Microtexture,” Surf. Coat. Tech., 325 308-317 (2017)
38. Nayak, B K, et al, “Self-organized Micro/nano Structures in Metal Surfaces by Ultrafast Laser Irradiation,” Optics and Lasers in Engineering, 48 940-949 (2010)
39. Sharma, M M, et al, “Effect of Surface Preparation on the Microstructure, Adhesion, and Tensile Properties of Cold-sprayed Aluminum Coatings on AA2024 Substrates,” J. Therm. Spray Tech., 24 410-422 (2015)
40. Sinha, A, et al, “Microscale Patterning of Semiconductor c-Si by Selective Laser-heating Induced KOH Etching, Semicond. Sci. Tech., 36 (8) 085002-085014 (2021)
41. Sinha, A, et al, “Nanosecond Pulsed Laser Patterning of Interdigitated Back Contact Heterojunction Silicon Solar Cells,” IEEE J. Photovolt., 10 (6) 1648-1656 (2020)
42. Spadaro, C, et al, “Laser Surface Treatments for Adhesion Improvement of Aluminum Alloys Structural Joints,” Radiat. Phys. Chem., 76 (8) 1441-1446 (2007)
43. Tan, N, et al, “Effects of Texturing Patterns on the Adhesion Strength of Atmosphere Plasma Sprayed Coatings, J. Mater. Research, 32 1682-1692 (2017)
44. Wenzel RN (1936) Resistance of solid surfaces to wetting by water. Ind Eng Chem 28:988-994.
45. Wong, R C P, et al, “Improvement of Adhesive Bonding in Aluminum Alloys Using a Laser Surface Texturing Process,” J. Mater. Process. Tech., 63 (1-3) 579-584 (1997)
46. Xie J, et al (1997) Mathematical modeling of melting during laser materials processing. J Appl Phys 81:3015-3022.
47. Zhan, X, et al, “Effect of Substrate Surface Texture Shapes on the Adhesion of Plasma-sprayed Ni-based Coatings,” J. Therm. Spray Tech., 30 270-284 (2021)
48. Zhang C, et al (2021) Nanosecond pulse laser assisted cold spraying of Al-Cu aluminum alloy. Coatings 11:267-272.
49. Zhang J, et al (2022) Laser micro-texture formation mechanism based on modified heat-mass transfers and hydrodynamic models. Int J Mech Sci 230:107528-107538.

1. A method for producing a microtextured surface on a substrate, the method comprising subjecting the surface of the substrate to a pulsed laser across the substrate at a controlled overlap of each pulsed laser to produce the microtextured surface.

2. The method of claim 1, wherein the method creates a plurality of features having an average height of about 0.1 μm to about 50 μm across the surface microtextured of the substrate and the average spacing between each of the features is from about 0.1 μm to about 50 μm.

3. The method of claim 1, wherein the substrate comprises a metal, ceramic, polymer, composite, alloy, or glass.

4. The method of claim 1, wherein the substrate comprises aluminum, copper, nickel, iron, or an alloy thereof.

5. The method of claim 1, wherein the substrate comprises aluminum or an aluminum alloy.

6. The method of claim 1, wherein the surface of the substrate is polished to a surface roughness of less than 1 μm prior to subjecting the surface of the substrate to the pulsed laser.

7. The method of claim 1, wherein the surface of the substrate roughness of has a 0.01 μm to 20 μm prior to microtexturizing.

8. The method of claim 1, wherein the pulsed laser is produced by an ytterbium fiber laser.

9. The method of claim 1, wherein the pulsed laser has a wavelength range of about 250 nm to about 11,000 nm.

10. The method of claim 1, wherein
the pulsed laser has an average power of about 1 W to about 1,000 W, or wherein the pulsed laser has a pulse frequency range of about 1 Hz to about 100 MHz, or wherein the pulsed laser has a pulse energy of from about 1 μJ to about 100 J.

11. (canceled)

12. (canceled)

13. The method of claim 1, wherein the pulsed laser has a diameter in the range of about 1 μm to about 100 mm.

14. The method of claim 1, wherein the surface of the substrate is subjected to the pulsed laser at a scanning rate of from about 0.1 mm/s to about 10,000 mm/s.

15. The method of claim 1, wherein the overlap between each pulsed laser along a direction of scanning is from about 0% to about 99.5%.

16. The method of claim 1, wherein the overlap between each pulsed laser along a direction of scanning is from about 10% to about 90%.

17. The method of claim 1, further comprising blowing air or inert gas over the surface of the substrate during microtexturizing.

18. (canceled)

19. The method of claim 1, wherein the pulsed laser is applied to the surface of the substrate using a galvanometer.

20. The method of claim 1, wherein the pulsed laser is mounted on a translational stage.

21. A substrate produced by the method of claim 1.

22. (canceled)

23. (canceled)

24. A substrate comprising at least one microtexturized surface and a coating comprising a metal powder in contact with the microtexturized surface.

25-30. (canceled)

31. An article comprising the substrate of claim 24.

32. (canceled)
